(19) United States
(12) Patent Application Publication
(10) Pub. No.: US 2015/0344363 A1
(43) Pub. Date: Dec. 3, 2015

(54) Titanium-Containing Aggregate, Method for its Manufacture, and Use Thereof

(71) Applicant: SACHTLEBEN CHEMIE GMBH, Duisburg (DE)

(72) Inventor: Djamschid AMIRZADEH-ASL, Moers (DE)

(21) Appl. No.: 14/655,065

(22) PCT Filed: Dec. 24, 2013
(86) PCT No.: PCT/DE2013/100440

§ 371 Date: Jun. 24, 2015

(30) Foreign Application Priority Data
Jan. 7, 2013 (DE) 10 2013 100 077.0

(51) Int. Cl. C04B 5/00; B01J 21/06; B01J 20/02; C05D 9/00; C08L 95/00; C08K 3/00; C09D 7/12; F27D 3/00; C04B 18/02

(52) U.S. Cl. CPC C04B 5/00; F27D 3/0033; B01J 21/063; B01J 20/0211; C04B 18/021; C08L 95/00; C08K 3/0033; C09D 7/1225; C05D 9/00; C08L 2555/52

(57) ABSTRACT

The invention concerns a titanium-containing aggregate obtainable by mixing and/or treating residues from the manufacture of titanium dioxide which are obtained during the manufacture of titanium dioxide using the sulphate and/or chloride process with basic slags from the manufacture of metals, a method for its manufacture and its use in metallurgical processes, as well as its use as an aggregate and/or filler for concrete, cement, asphalt, refractory materials, repair compounds and sizes.

The invention relates to a titanium-containing aggregate, to a method for its manufacture and to the use thereof in metallurgical processes, in particular for charging into a cupola furnace, a smelting furnace as well as a shaft and blast furnace, as an aggregate and/or filler for concrete, cement, asphalt, refractory materials, repair compounds, sizes, for coatings which are almost impermeable to water such as landfill coverings, to backfill mineshafts and underground cavities, to seal and solidify subsoil, for landscaping or road construction and for use in metallurgy in order to increase the durability of furnace linings and/or as a slag-forming agent, to control the viscosity of the slag in metallurgical vessels, to reduce the melting point of the slags, as a fertilizer or aggregate (feedstock) for cement manufacture, or as a catalyst.

When manufacturing titanium dioxide using the sulphate process, titanium dioxide-containing feedstock (slag, ilmenite) is dried and milled and then digested with concentrated sulphuric acid. The reaction between the feedstock and the concentrated sulphuric acid is carried out in batches in lined reactors. During the digestion reaction, all of the metal oxides present in the feedstock that react with sulphuric acid are transformed into the corresponding metal sulphate. After the reaction, a solid mass (digestion cake) is left behind which is dissolved with water and/or dilute sulphuric acid. The digestion solution, which is known as black liquor, is completely freed from the undissolved ingredients (digestion residues, gangue material) by sedimentation and filtration processes. Further downstream in the process, a metatitanic acid suspension is produced from the solids-free digestion solution by hydrolysis. The metatitanic acid is calcined in a rotary kiln after washing, bleaching and optional salt treatment, as well as filtration.

The digestion residues which, depending on the feedstock employed, essentially consist of titanium dioxide, silicon dioxide, aluminium and iron oxide and adsorbed metal sulphates, for example titanyl sulphate, iron sulphate, magnesium sulphate, aluminium sulphate as well as adsorbed sulphuric acid, are separated by the usual solid/liquid separation processes such as sedimentation and filtration. These process steps remove the majority—but not all—of the soluble components of the digestion residue still adsorbed on the TiO₂ and the remaining adsorbed metal sulphates and sulphuric acid. The digestion residues which are obtained during the solid/liquid separation processes as a sediment or filter cake are mashed with water and/or dilute sulphuric acid and after neutralization, usually with calcium hydroxide in suspension, and renewed filtration, they are dumped.

From the point of view of economics, the disadvantage with this procedure is the proliferation of equipment and steps in the process, as well as the large consumption of expensive neutralizing agents such as Ca(OH)₂ which is required because of the sulphuric acid which is adsorbed on the digestion residue and not washed out. The metal sulphates which are adsorbed on the digestion residues are another problem. In addition, the mixture of digestion residues and gypsum cannot be dewatered sufficiently. This makes handling and transport more difficult, as this mixture has residual moisture contents of significantly more than 25% and also behaves thixotropically. Furthermore, filtrates from several filtration and washing steps, which have different compositions and different pHs (acid to slightly alkaline), have to be treated and worked up so that they can be disposed of appropriately.

During the production of titanium dioxide using the chloride process, in a first step, titanium tetrachloride is obtained by chlorination of titanium-containing feedstock. The chlorination is carried out at temperatures of about 1000° C. in a fluidized bed reactor in the presence of coke. This produces volatile metal chlorides which, when removed from the reactor, also entrain finely divided bed material formed from unreacted TiO₂ feedstock and other components such as SiO₂ and coke, for example. This separated cyclone dust is then washed and, in the dry state, normally has the following composition:

TiO₂ 15%-80% by weight
Carbon 20%-60% by weight
SiO₂ 5%-15% by weight
as main components. The moisture content of the initial filter cake is usually 20% to 40% by weight.

The disadvantage with these filter cakes is that, when being processed further, the filter cake reacts as an acid because of this type of processing and thus is highly corrosive during further processing or utilization, for example in metallurgical processes. For the filter cake to be able to be used in an economically viable manner, the filter cake has to be neutralized; this is complicated to carry out conventionally and of little economic advantage.

The digestion residue from the sulphate process may still contain 20% to 60% by weight of titanium dioxide, depending on the feedstock used and the digestion reaction yield. Instead of dumping this residue, it would be desirable to be able make use of the TiO₂ content that is still present.

Thus, DE 29 51 749 C2 describes a process in which 5% to 95% by weight of a titanium dioxide-containing digestion residue which is obtained by rotary filtration with subsequent washing is digested together with 95% to 5% by weight of finely divided slag in sulphuric acid with a content of >86% by weight. DE 40 27 105 A1 describes a process in which the digestion residue is digested with concentrated sulphuric acid with energy being supplied, for example in endless screws, rotary tubes or similar equipment.

According to the process described, the digestion residues, which have not undergone any other pre-treatments apart from rotary filtration and washing, are difficult to handle because of their high residual moisture content (for example 30% by weight) and thus require higher sulphuric acid concentrations and the supply of energy for the digestion reaction and, because of the adsorbed sulphuric acid content, are highly corrosive.

DE 197 25 018 B4 and DE 197 25 021 B4 disclose methods for processing digestion residues the process steps and streams of which are still capable of being optimized despite the attempted improvements over the prior art.

According to EP 1 443 121 A1, the digestion residues which are obtained upon digestion of titanium dioxide-containing feedstock with sulphuric acid are filtered in a membrane filter press and the filter cake containing the digestion residues can be neutralized with a solution or suspension which reacts as a base.

Overall, all of these methods suffer from the disadvantage that from an economic viewpoint, a lot of equipment and process steps are necessary and a high consumption of expensive neutralizing agents such as Ca(OH)₂ or NaOH is necessary. The disadvantage of this method also lies in the fact that after the last wash, the digestion residues are still strongly acidic and then have to be neutralized with alkali or alkaline-earth oxides, hydroxides or carbonates in order to be able to be utilized as an aggregate or filler.

The use of residues of this type from TiO₂ production (TiO₂ residues) as an aggregate in the metallurgical industry is known.

Thus, DE-C-4419819 discloses a titanium-containing aggregate consisting of TiO₂ residues and other substances. DE-C-19705996 discloses a method for the manufacture of a TiO₂-containing aggregate. In that patent, a mixture of TiO₂ residues and iron or iron compounds is heat treated at 200° C. to 1300° C. One disadvantage of this technical solution is the cumbersome metering and mixing as well as the subsequent heat treatment of the TiO₂ residues with the respective further components of the aggregate.

EP-A-0 611 740 describes the use of residues from TiO₂ production (TiO₂ residues) with other components as a titanium-containing aggregate for increasing the durability of the refractory lining of a furnace. In this regard, TiO₂-containing shaped articles such as briquettes, pellets or granulates are manufactured.

The action of residues from TiO₂ production when charged into metallurgical vessels is based on the formation of high temperature-resistant and abrasion-resistant Ti(C,N) compounds which have a temperature-dependent solubility in pig iron. Below the solubility limit, which may in particular be the case in damaged areas of the framework due to an increased dissipation of heat to the outside, the Ti(C, N) compounds precipitate out of the pig iron, they are deposited on the more severely worn regions of the wall construction and this results in an intrinsic “heat repair effect”. The elements carbon and nitrogen are required in order to form the titanium carbonitrides. In particular, a lack of nitrogen in metallurgical vessels limits the formation of titanium carbonitrides and thus their titanium nitrides.

Thus, the aim of the invention is to propose cost-effective processing and utilization of residues which are obtained in the production of titanium dioxide and, as described above, primarily react as acids.

The inventors have surprisingly discovered that, by transforming metal slags, in particular those which are obtained during the manufacture of steel and iron or during recycling thereof, with titanium-containing materials that are residues which are obtained during the manufacture of titanium dioxide using the sulphate and/or chloride process, a product is obtained which can be used as an aggregate and/or filler for concrete, cement, asphalt, refractory materials, for coatings which are almost impermeable to water such as landfill coverings, to backfill mineshafts and underground cavities, to seal and solidify subsoil, for landscaping or road construction and for use in metallurgy in order to increase the durability of furnace linings and/or as a slag-forming agent, to control the viscosity of the slag in metallurgical vessels, or as a fertilizer or aggregate (feedstock) for cement manufacture.

The titanium-containing materials used for the manufacture of the aggregate of the invention in general contain 10% to 100% by weight, preferably 20% to 95% by weight of TiO₂, usually as TiO₂ or as a titanate with other metals. Synthetic titanium dioxide-containing materials which may be used could be those from the production of titanium dioxide using the sulphate or chloride process, as an intermediate or coupling product or residues from regular TiO₂ production. It is also possible for the synthetic titanium-containing materials used to be residues or waste from the chemical industry or paper industry, or from titanium production.

Typical titanium-containing residues are titanium-containing residues from the production of TiO₂ using the sulphate process or the chloride process. Similarly, spent titanium-containing catalysts, for example DENOX catalysts or Claus catalysts, may advantageously be used in the context of the invention. Furthermore, materials such as natural titanium-bearing materials, for example ilmenite, ilmenite sand, rutile sand and/or titanium slags (for example sorel slag) which are capable of forming refractory titanium carbonitrides under the conditions at the reaction site in the blast furnace, may be used. The synthetic and natural titanium-containing supports cited above may be used alone or as mixtures in the manufacturing process.

The residues from TiO₂ manufacture that are employed may be used as wet-filtered filter cake or as powder. In addition, these residues may be used in the acidic, washed, un-neutralized, partially neutralized or neutralized form for the manufacture of the aggregate of the invention.

In addition to residues from the manufacture of TiO₂, the aggregate in accordance with the invention may contain other synthetic and/or natural titanium dioxide-containing materials selected from the following materials or their mixtures:
intermediate, coupled and/or ready-prepared products from the manufacture of titanium dioxide. In this regard, the materials may originate both from the manufacture of titanium dioxide using the sulphate process and from the manufacture of titanium dioxide using the chloride process. The intermediate and coupling products may have been extracted from regular TiO₂ production;
residues from the chemical industry, for example from TiO₂-containing catalysts, again as an example from DENOX catalysts or from paper manufacture (known as getter);
titanium ores, titanium slags as well as rutile or ilmenite sand.

Depending on the intended use, the aggregate of the invention may contain other process materials and/or additives, for example carbon-containing materials, reducing carbon and/or metal oxides, iron oxide being a further example.

In addition to the metal slags and the residues from TiO₂ manufacture, the aggregate in accordance with the invention can thus also contain other titanium dioxide-containing materials selected from titanium ores, titanium dioxide-rich slags, synthetic titanium dioxide-containing materials or mixtures of two or more of these materials.

As a rule, the synthetic titanium dioxide-containing materials used for the manufacture of the aggregate in accordance with the invention contain approximately 10% to 100% by weight, preferably 20% to 95% by weight of TiO₂ (calculated with respect to the total titanium content).

Depending on the composition and application, the aggregate may undergo a heat treatment, preferably drying, particularly preferably a heat treatment at temperatures in the range 100° C. to 1200° C.

The aggregate in accordance with the invention contains 5% to 90%, preferably 10% to 85%, particularly preferably 20% to 85%, more particularly preferably 30% to 80% by weight of TiO₂ (calculated with respect to the total titanium content).

In one application, the aggregate in accordance with the invention may have a granulometry in the range 0 to 15 cm, particular in the range >0 to 10 cm, particularly preferably in the range >0 to 8 cm and more particularly preferably in the range >0 to 5 cm, respective upper limits included.

In another application, the aggregate in accordance with the invention may in particular also have a fineness of >0 to 100 mm, preferably >0 to 10 mm and particularly preferably >0 to 3 mm, respective upper limits included.

In order to neutralize the residues, in accordance with the invention, slags are used which are obtained as non-metallic substances during the production of metals from the feedstock which is employed. These slags are mixtures of oxides formed from basic oxides which are generated during metal extraction in ore smelting and have porous to massive properties. Slags are also used as a secondary raw material in civil engineering as aggregate for road bases or as an additive for cement. These non-metallic materials are known in the art as smelter slag and iron slag.

Smelter slags are slags which are obtained during the production of metals such as aluminium, chromium, copper, lead etc. They are then known as aluminium, chromium, copper and lead slags. Preferably, a slag known as aluminium salt slag is used as the smelter slag. In addition to Al₂O₃, this slag also contains considerable quantities of aluminium nitride. The fraction of aluminium nitride may be up to 30% by weight or more, depending on the procedure and method being carried out. Because of its AlN content, in general, the aluminium salt slags cannot be utilized since on contact with air or water, AlN reacts to form unwanted gaseous ammonia. Methods for processing and recycling such Al salt slags are known. In one processing method, the salt slag is comminuted and separated from the metallic portion by screening. Next, the salt components are washed out with water and then the gaseous ammonia which is generated is transformed into aluminium sulphate by process gas purification. After filtering off the water-insoluble oxides and crystallizing out the dissolved smelting salts, products are obtained which can be used as a cheap feedstock for the manufacture of cement clinker and mineral wool. However, despite its complicated preparation, a residual fraction of aluminium remains unreacted in the product as AlN or as ammonia, whereupon a clear smell of ammonia still arises. Only heat treatment, in particular complete drying, allows the ammonia to volatilize. However, this method is very complicated and not economical. A further disadvantage of smelter slags is generally that they react as strong alkalis and as a result, options regarding their further utilization are very restricted.

The presence of nitride in the application in accordance with the invention, however, has the advantage that, after manufacturing the aggregate in accordance with the invention, for example, when charged into metallurgical smelting furnaces, the yield for the formation and deposition of titanium nitride and/or titanium carbonitride on refractory linings can be substantially accelerated.

Iron slags are blast furnace, steelworks and secondary metallurgical slags. Steelwork slags are classified according to the manufacturing process of the steel. As an example, LD slags (LDS) are produced during the production of steel using the Linz-Donawitz process, electric furnace slags are produced during the production of steel using the electric furnace process and SM slags are produced during the production of steel using the Siemens-Martin process. The vast majority of iron slags are used in civil engineering and in road construction.

Steelwork slags and also LD slags or electric furnace slags may be used in the context of the invention. These have the advantage that on the one hand the free CaO and MgO are used for neutralization of the residues from TiO₂ manufacture, on the other hand the other components such as CaO, MgO, Al₂O₃, dicalcium silicate, tricalcium silicate, dicalcium ferrite, calcium wüstite, magnesium wüstite, Fe₂O₃, FeO may be used as slag-forming agents and/or to adjust the viscosity of the slag and/or to reduce the melting point of the slag. Furthermore, when charged into the metallurgical vessels, the iron content is made useable, thus saving on feedstock and thus protecting natural resources.

Thus, iron slags contain SiO₂, Al₂O₃, CaO and/or MgO as the main components. They also contain iron oxide, free iron and metal oxides as well as hydroxides. Because of the mineralogical and chemical composition as well as the physical properties of these slags, as a rule further processing steps are required before the slags can be utilized.

TABLE 1
Characteristic mineral phases of steelwork slags

| Phase | Description |
|---|---|
| 2CaO * SiO₂ | Dicalcium silicate |
| 3CaO * SiO₂ | Tricalcium silicate |
| 2CaO * Fe₂O₃ | Dicalcium ferrite |
| FeO | Wustite |
| (Ca, Fe)O | Calcium wustite |
| (Mg, Fe)O | Magnesium wustite |
| Free CaO | Free lime |
| Free MgO | Periclase |

As an example, steelwork slags generally always contain free oxides, in particular free lime (CaO); on the other hand, MgO-rich slags also contain free MgO (Table 2).

TABLE 2
Characteristic solids content of steelwork slags
Main components as % by weight, data in accordance with
DIN 52100, Part 2, Chapter 6.1:

| | Steelwork slag | | | |
|---|---|---|---|---|
| | LD slag | | Electric furnace slag | |
| | Mean of tested | | Mean of tested | |
| | samples | Max value | samples | Max value |
| SiO₂ | 18 | 14 | 13 | 18.5 |
| Al₂O₃ | 2.0 | 5.0 | 6 | 9.5 |
| CaO | 49 | 53 | 26 | 36 |
| Free CaO | 6 | 9.5 | 0.4 | 0.8 |
| MgO | 2.5 | 6.0 | 5 | 10 |
| Total Fe | 18 | 22 | 26 | 30 |

Examples of the % by weight of the components of a basic slag from a cupola furnace are as follows:

### SiO₂ 25% to 30%

### CaO 45% to 55%

### FeO 0.5% to 2.5%

### Al₂O₃ 5% to 15%

### MgO 1% to 2%

### MnO 1% to 2%

Using these slags in civil engineering, for example in the form of granulates for cement or road construction for the manufacture of road bases, is often limited because of the free lime content and/or the free MgO which is/are present. Both the free lime and also the free MgO can hydrate when water is added; this is associated with an increase in volume. This hydration process means that the slags can become fissured and may even disintegrate completely. This leads to unwanted expansion of a carriageway for road construction or of a concrete.

The free lime fraction in the steelwork slag can be up to 10% by weight or more. The free fraction of MgO may be 8% by weight or higher. Depending on the lime content of LD slags, these may be suitable as road construction materials (with a low lime content) or can be processed into fertilizers. This means that the steelwork slags are highly alkaline, which means that applications are substantially limited.

The slags cited above may be used individually or as a mixture for the manufacture of titanium-containing aggregates.

The aggregate of the invention may be manufactured by mixing the titanium-containing residues from the manufacture of titanium dioxide with the slags from metal extraction. In order to manufacture the aggregate of the invention, various methodologies are envisaged; these will now be described by way of example.

Metal slags are mixed with residues from TiO₂ manufacture, for example by mixing in a mixer. The slags employed may have a granulometry of 0 to 200 mm, preferably 0 to 50 mm and particularly preferably <5 mm. The residues from TiO₂ manufacture using the sulphate process and chloride process may be used individually or as a mixture as filter cake.

Furthermore, metal slags can be mixed with residues from TiO₂ manufacture by mixing, for example in a mixer and then dried in a combined milling and drying unit (such as a ball mill) and micronized at the same time. The metal slags used may have a granulometry in this case of 0 to 80 mm, preferably 0 to 50 mm and particularly preferably <20 mm. The residues from TiO₂ manufacture using the sulphate process may be used individually or as a mixture as filter cake. In this regard, a finely divided, dry aggregate with a granulometry of 100%<4 mm, preferably <2 mm and particularly preferably <1 mm can be obtained.

Depending on the application, metal slags with residues from TiO₂ manufacture can be mixed by mixing, for example in a mixer and then briquetted, pelletized or sintered on a sinter belt using processes which are known in the art. Shaped articles of this type may have a grain size in the range 0.5 cm to 10 cm, preferably 2 to 8 cm.

Coarsely divided metal slags may be comminuted in a crusher and then milled. It is also possible to mill the metal slags initially in a combined milling and drying unit or to dry in a dryer prior to comminution/milling. Next, the milled slag is mixed with the wet-filtered residues from TiO₂ manufacture. If necessary, the mixture may then be dried or heat treated.

Following milling, the slag employed has an oversize percentage of 100%<5 mm, in particular 100%<3 mm and most particularly 100%<1 mm. The finished aggregate product has a granulometry of >0 to 5 mm, preferably >0 to 3 mm and particularly preferably >0 to 1 mm.

In order to neutralize the acidic residues from titanium dioxide production, in accordance with the invention, metal slags which react chemically as bases are used. The term “basic metal slags” as used in the invention should be understood to mean metal slags which react chemically as bases. These metal slags may have a basicity, given by the slag number, of more than 0.8, in particular more than 1, more particularly more than 1.2 and especially particularly more than 1.5. This slag basicity is the metallurgical slag ratio B and is based on the molar ratio of the alkaline components such as CaO, MgO, to the acidic components in the slag, such as SiO₂, which is known as the slag number. The slag ratio B is an empirical parameter which in its simplest form expresses the ratio by weight of CaO and SiO₂ in metallurgical slags. Since this does not closely resemble actual conditions, other slag components (e.g. MgO, Al₂O₃) are assigned to the basic and acidic fractions. The “B” in the term “slag basicity B” therefore does not correspond to the chemical basicity. A basicity of more than one means the slag is termed basic and a basicity of less than one is termed an acidic slag.

If the residues from the manufacture of TiO₂ are used as acidic filter cakes, in particular washed, then the inventive addition of a specific quantity of metal slag which reacts in a strongly alkaline manner means that a neutral product can be obtained which is ideally suited to the applications mentioned above. In this manner, the otherwise disadvantageous alkaline property of slags is exploited in order to neutralize the residues from manufacture of TiO₂ which react in an acidic manner. As a rule, the slags and the residues from the manufacture of TiO₂ can be mixed in quantities which are a function of their pHs that produce a pH in the produce which is approximately neutral. The product obtained thus often has a pH of 5 to 11, preferably 6 to 10. The granulometry is in the ranges given above.

In accordance with the invention, in this manner the acidic residues from the production of titanium dioxide can be mixed with the basic metal slags directly from the chamber filter press or after washing to reduce the adsorbed acids, but without using aqueous solutions containing neutralizing agents. In this manner, in accordance with the invention, the titanium-containing residues and the basic metal slags are used in a quantity such that the mixture obtained has a pH in the neutral range of 5-12, preferably 6 to 10 or more preferably 6 to 8. As a rule, this is obtained with approximate quantities of between 50 and 90 parts by weight of residues from the production of titanium dioxide and 50 to 10 parts by weight of basic metal slags.

Thus, the invention provides an aggregate formed from titanium-containing residues from the production of titanium dioxide and slags from metal extraction which can be utilized as an aggregate and/or filler and which can be manufactured by means of a process in accordance with the invention which is inexpensive, energy-efficient and technically simple to carry out for the preparation of the metal slags and residues obtained from the manufacture of TiO₂.

Furthermore, the invention provides a titanium-containing aggregate for use in metallurgical processes, in particular in metallurgical vessels and smelter plants, in particular for use in blast, cupola and shaft furnaces.

The present invention further provides a titanium-containing aggregate for use in refractory materials, in gunning materials, gutter materials and/or repair compounds.

A further aim of the present invention is to provide an aggregate for use in sizes for the formation of a thin coating on mouldings, cores or castings. This satisfies various requirements such as heat insulation, smoothing, separation etc.

In a still further aspect of the present invention, a titanium-containing aggregate is provided for injection into metallurgical furnaces to increase the durability of the furnace linings and also to influence the viscosity of the slag in the metallurgical furnace.

In a still further aspect of the present invention, a titanium-containing aggregate is provided for charging into metallurgical furnaces to increase the durability of the furnace linings and simultaneously to act as a slag-forming agent.

In a still further aspect of the present invention, a titanium-containing aggregate is provided for charging into metallurgical furnaces to increase the durability of the furnace linings and simultaneously to act as a slag-forming agent and to regulate the viscosity of the slag.

In a still further aspect of the present invention, a titanium-containing aggregate is provided for charging into metallurgical furnaces to increase the durability of the furnace linings and simultaneously to act as a slag-forming agent and to reduce the melting point of the slag.

In a still further aspect of the present invention, a titanium-containing aggregate is provided for use in a taphole material.

In a still further aspect of the present invention, a titanium-containing aggregate is provided for use as an aggregate for construction materials, for example for concrete and/or cement and in road construction.

In a still further aspect of the present invention, a titanium-containing aggregate is provided for use as a filler and/or pigment.

In a still further aspect of the present invention, a titanium-containing aggregate is provided for low water-permeability coatings such as landfill coverings, to backfill mineshafts and underground cavities, to seal and solidify subsoil, for landscaping or for road construction.

In a still further aspect of the present invention, a titanium-containing aggregate is provided for use as a fertilizer or aggregate (feedstock) for cement manufacture.

In one implementation of the invention, the digestion solution from the manufacture of TiO₂ using the sulphate process is neutralized prior to filtration with metal slags, then filtered and if necessary, washed.

In another implementation of the invention, the digestion solution from manufacture using the sulphate process or the cyclone dust from manufacture using the chloride method is initially filtered and washed to remove sulphate or chloride respectively. Next, the filter cake is elutriated in water and neutralized by adding metal slag and filtered off. Filtration and washing is carried out in accordance with prior art techniques.

In a further implementation of the invention, the residues from the manufacture of TiO₂ are added directly after production of the slag melt in the steelwork at high temperatures. Addition may be carried out directly at these high temperatures or during cooling of the melt. Furthermore, the addition can also be carried out in downstream steps during the preparation of the metal slags, directly in the respective production units.

In this manner, a titanium-containing aggregate can be manufactured which has a granulometry of up to 15 cm. in accordance with the prior art, the aggregate can be broken up into different grain sizes and prepared in various screen fractions. The granulometry which is set depends on the application for the aggregate.

In accordance with the invention, it is also possible for the residues from the manufacture of titanium dioxide to undergo a comminution step together with the slags such as milling, crushing or similar processes, whereby particularly intimate admixing and thus a particularly uniform neutralization within the mixture can be obtained. The aggregate obtained in this manner may have a granulometry of 0.01 μm to 3 mm, in particular 0.1 μm to 2 mm and is particularly suitable for injecting into metallurgical vessels via injecting lances.

If the aggregate is used in a metallurgical vessel, for example in a blast furnace, then in the case of addition via the head of the furnace, the granulometry of what is known as the burden column may be up to 150 mm, preferably up to 100 mm. However, if the titanium-containing aggregate is injected into the blast furnace via the injecting lances, then the granulometry is adjusted by smashing or milling to <10 mm, preferably <5 mm and most particularly <3 mm. In this implementation, the residues from the manufacture of TiO₂ may be used unwashed, unwashed and partially or completely neutralized, washed but acidic, or washed and partially or completely neutralized. The residues from the manufacture of TiO₂ may be used in the form of a wet-filtered cake or as a dry material.

In accordance with the invention, a process can be provided which, by forming high temperature-resistant and abrasion-resistant Ti(C, N) compounds on the one hand, can protect the furnace linings from premature wear, and on the other hand can reduce the viscosity of the slag as it forms in the blast furnace and thus can improve the gas flow in the furnace, allow the slag to be removed easily after tapping and also can optimize matching of the quality of the liquid blast furnace slag to the corresponding blast furnace slag product.

The advantages of this aggregate in accordance with the invention, when charged into a metallurgical vessel such as a blast furnace, are that charging titanium dioxide or titanium compounds improves the gas flow in the furnace due to the formation of high temperature-resistant and abrasion-resistant Ti(C, N) compounds which have a temperature-dependent solubility in pig iron and thus can exert an influence on the viscosity of the liquid pig iron; also, the viscosity of the liquid blast furnace slag is reduced because of the further components such as CaO, Al₂O₃ and/or MgO. In addition, when the blast furnace melt is tapped, the slag is advantageously as liquid as possible and has a low viscosity. If this does not occur, problems with tapping the pig iron and slag may arise in the gutter system and in particular in the granulation unit, for example, in which the liquid slag is granulated for application in road construction or as an additive to cement.

The blast furnace slag forms in the blast furnace in the liquid form at the temperatures prevailing in it. The job of the slag is to take up the non-reducible components of the burden and to ensure desulphurization of the furnace. Blast furnace slag primarily consists of MgO, Al₂O₃, CaO and SiO₂. The quality of the liquid blast furnace slag is determined by its chemical composition and the heat treatment conditions. An essential feature which influences the quality of blast furnace lump slag is primarily its porosity. This can be influenced, inter alia, by suitable additives to the liquid blast furnace slag. These additives are intended to regulate the release of the gases dissolved in the liquid slag. In this manner, on the one hand the release of the gases can be inhibited or at least limited or on the other hand it can be intensified so that the majority of the released gases can escape from the slag before solidification upon cooling. If the viscosity of the blast furnace slag is influenced by these additives so that the viscosity is reduced, then escape of the gases during solidification becomes easier and gas bubble entrapment is prevented.

1. A titanium-containing aggregate obtainable by mixing and/or treatment of residues from the manufacture of titanium dioxide which are obtained during the manufacture of titanium dioxide using the sulphate and/or chloride process, with basic slags from the manufacture of metals, wherein the titanium-containing aggregate has a pH in a range of 5 to 12.

2. The titanium-containing aggregate as claimed in claim 1, with a granulometry of >0 μm to 100 mm respective upper limits included.

3. The titanium-containing aggregate as claimed in claim 1, wherein slags with a slag number B of more than 0.8, are used as the basic slag from the manufacture of metals.

4. The titanium-containing aggregate as claimed in claim 1 further comprising, in addition to the residues from the manufacture of TiO₂, other synthetic and/or natural titanium dioxide-containing materials selected from the group consisting of:
intermediate, coupled and/or ready-prepared products from the manufacture of titanium dioxide using the sulphate process and from the manufacture of titanium dioxide using the chloride process or from regular TiO₂ production;
residues from the chemical industry, for example from TiO₂-containing catalysts, for example from DENOX catalysts or from paper manufacture;
titanium ores, titanium slags,
rutile or ilmenite sand, and
mixtures thereof.

5. A method for the manufacture of the aggregate as claimed in claim 1, wherein residues from the manufacture of titanium dioxide which are obtained during the manufacture of titanium dioxide using the sulphate and/or chloride process are mixed with basic slags from the manufacture of metals in a quantity such that the titanium-containing aggregate obtained has a pH in the range of 5 to 12.

6. The method for the manufacture of the aggregate as claimed in claim 5, in which the mixture obtained additionally undergoes a neutralization.

7. (canceled)

8. An article, comprising:
concrete, cement, asphalt, refractory materials, or repair compounds; and
the titanium-containing aggregate as claimed in claim 1.

9. A coating comprising the titanium-containing aggregate as claimed in claim 1.

10. A fertilizer comprising the titanium-containing aggregate as claimed in claim 1.

11. A catalyst or an absorption agent for removing heavy metals from water comprising the titanium-containing aggregate as claimed in claim 1.

12. A process, comprising:
charging the titanium-containing aggregate as claimed in claim 1 into a metallurgical furnace; and
increasing the durability of a furnace lining while simultaneously acting as a slag-forming agent to regulate viscosity of slag.

13. A method of producing titanium-containing aggregate, comprising:
obtaining residues from a manufacture of titanium dioxide using a sulphate and/or chloride process; and
mixing and/or treating said residues with basic slags from a manufacture of metals, thereby producing a titanium-containing aggregate,
wherein the titanium-containing aggregate has a pH in a range of 5 to 12.
